(19) United States
(12) Patent Application Publication
(10) Pub. No.: US 2007/0202476 A1
(43) Pub. Date: Aug. 30, 2007

(54) Techniques for inspecting an electronic device

(76) Inventor: Mark Williamson, Boise, ID (US)

Correspondence Address: FLETCHER YODER (MICRON TECHNOLOGY, INC.), P.O. BOX 692289, HOUSTON, TX, 77269-2289, US

(21) Appl. No.: 11/347,435

(22) Filed: Feb. 3, 2006

(51) Int. Cl. G09B 19/00

(52) U.S. Cl. 434/236

(57) ABSTRACT

A novel method of classifying physical structures on a substrate. In certain embodiments, the method includes receiving a perceived image of a substrate, and classifying a physical structure on the substrate by comparing the perceived image to a simulated image. The perceived image may be received from a RDA tool, and the simulated image may be generated by software that models the effect of a candidate structure, i.e., a simulated physical structure, on radiation of the sort used to obtain the perceived image. Comparing the perceived image to the simulated image may include comparing the perceived image to a library of simulated images or analyzing the perceived image with a simplified model that is based on simulated images. By comparing the perceived image of an unknown physical structure to a simulated image of a known candidate structure, the unknown physical structure may be classified.

### BACKGROUND OF THE INVENTION

1. Field Of The Invention

The present invention relates generally to real-time defect analysis tools and, more specifically, to techniques for extracting information about a physical structure on a substrate by using simulated images to correlate a perceived image of the substrate with the physical structure.

2. Description Of The Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Generally, real-time defect analysis (RDA) tools monitor the performance of semiconductor manufacturing lines. Typically, these tools detect misprocessed substrates in the manufacturing line using non-destructive measurement techniques. Examples of RDA tools include bright-field inspection tools, dark-field inspection tools, and electron-beam inspection tools. In operation, RDA tools may detect that a manufacturing process is scratching substrates, shedding particles on substrates, under or over etching substrates, forming electronic devices on substrates with a dimension or measure that is outside of a specified tolerance, or leading to other types of defects. Currently, many of the electronic devices that are manufactured on substrates include features that are smaller than 65 nanometers, so even very small defects on the substrate may affect the performance of the electronic devices. However, by quickly detecting even very small defects on substrates, before a large number of substrates are processed in the manufacturing line, RDA tools may limit the number of substrates that are misprocessed.

Generally, RDA tools detect defects by directing some form of radiation toward a substrate and sensing radiation returning from the substrate. Often, the radiation returned from the substrate is sampled over an area to form a perceived image of the substrate. For instance, a RDA tool may illuminate a substrate with electromagnetic radiation, e.g., ultraviolet light, and sense the electromagnetic radiation returned from the substrate to form a perceived image. In another example, a RDA tool may direct an electron-beam toward a substrate and sense electrons returned from the substrate. Often, a defect on the substrate leaves a signature in the perceived image, e.g., a dark spot in the perceived image may correspond to a light-absorbent particle on the substrate. Similarly, the electronic devices manufactured on the substrate may leave signatures in the perceived image, e.g., an interconnect line may appear in the perceived image as a dark band. Generally, by analyzing the perceived image to identify the signatures of defects among the signatures of the electronic devices being manufactured, the RDA tool may detect misprocessed substrates.

Unfortunately, RDA tools are typically not able to extract all the information contained within a perceived image. Many of the physical structures on the surface of a substrate are so small that it is difficult to correlate a signature in the perceived image with the physical structure that created the signature. Indeed, in the case of RDA tools employing electromagnetic radiation, many physical structures are smaller than the wavelength of the electromagnetic radiation directed at the substrate. These sub-wavelength physical structures often introduce nonlinear distortions into the perceived image. Various diffraction effects and other phenomena are believed to cause distortions in the perceived image. For example, the signature of an isolated line on the substrate may appear narrower in a perceived image than the signature of densely packed lines of the same width. With the isolated line, higher order diffraction beams from neighboring lines do not spill over and increase the density of the image from an isolated line. As a result, the isolated line appears narrower than it actually is. Similar phenomena may affect the signature of an irregularly shaped physical structure, such as a particle or a scratch. These distortions often make it difficult to accurately identify and characterize the physical structure that produced a given signature in a perceived image. As a result, some information relevant to the classification of physical structures appearing in the perceived image often goes unused.

Accordingly, there is a need for a technique that correlates a signature in a perceived image with the physical structure that produced the signature. Embodiments of the present invention may address this need and others.

### BRIEF SUMMARY

The present invention provides a novel method of classifying physical structures on a substrate. In certain embodiments, the method includes receiving a perceived image of a substrate, and classifying a physical structure on the substrate by comparing the perceived image to a simulated image. The perceived image may be received from a RDA tool, and the simulated image may be generated by software that models the effect of a candidate structure, i.e., a simulated physical structure, on radiation of the sort used to obtain the perceived image. Comparing the perceived image to the simulated image may include comparing the perceived image to a library of simulated images or analyzing the perceived image with a simplified model that is based on simulated images. By comparing the perceived image of an unknown physical structure to a simulated image of a known candidate structure, the unknown physical structure may be classified.

### BRIEF DESCRIPTION OF THE DRAWINGS

Advantages of the invention may become apparent upon reading the following detailed description and upon reference to the drawings, in which:

FIG. 1 is a flowchart depicting an exemplary embodiment of a technique for classifying a physical structure on a substrate based on a comparison between a perceived image and simulated images;

FIG. 2 is a flowchart depicting an exemplary embodiment of the technique of FIG. 1, wherein a perceived image of a substrate is received by comparing perceived images of a referenced die and an inspected die, and wherein a potential defect is classified by comparing a perceived image of the potential defect to simulated images of candidate structures;

FIG. 3 is an exemplary embodiment of a library-based method for comparing the perceived image to simulated images of candidate structures, wherein a perceived image is matched to a similar simulated image in a library of simulated images;

FIG. 4 is an exemplary embodiment of a simplified model-based method for comparing the perceived image to simulated images of candidate structures, wherein a physical structure is classified by inputting a feature of the perceived image into a simplified model that correlates a feature of the simulated images to a corresponding feature of the candidate structures;

FIG. 5 is a flowchart depicting another exemplary embodiment of the technique of FIG. 1, wherein a physical structure on the substrate is classified by identifying the physical structure as negligible and removing its signature from the perceived image; and

FIG. 6 is a flowchart depicting another exemplary embodiment of the technique of FIG. 1, wherein a dimension of a physical structure on the substrate is measured.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming but would nevertheless be a routine undertaking of design, fabrication, and manufacture for those of ordinary skill having the benefit of this disclosure.

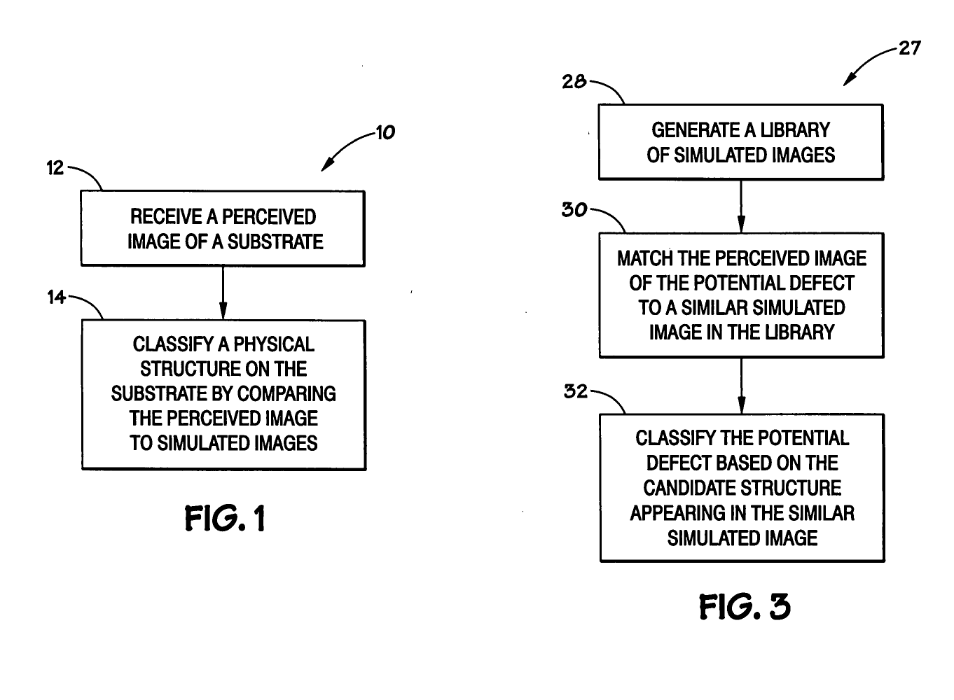

Turning to the drawings, FIG. 1 is a flowchart depicting an exemplary embodiment of a classification method 10 for classifying a physical structure on a substrate. In the present embodiment, the classification method 10 includes receiving a perceived image of a substrate, as illustrated by block 12, and classifyng a physical structure on the substrate by comparing the perceived image to simulated images, as indicated by block 14. Advantageously, as is described in greater detail below, the classification method 10 may facilitate the classification of sub-wavelength and near-sub-wavelength physical structures. In subsequently discussed embodiments, the physical structure is classified by comparing its appearance, or signature, in the perceived image to a signature of a candidate structure in a simulated image. Once a similar simulated image is identified, the physical structure in question is classified as being similar to the candidate structure appearing in the matching simulated image. In other words, by matching a perceived image to a simulated image, an unknown physical structure is classified based on a known candidate structure.

The classification method 10 is discussed in greater detail below. To clarify terms, a “perceived image,” as used herein, is the output of a sensor that samples radiation returned by a substrate over some area, e.g., a photograph of a substrate surface illuminated by ultraviolet light. A perceived image is not necessarily the result of sampling an entire area simultaneously. The substrate may be scanned by a beam of radiation or sequentially illuminated with radiation of different wavelengths, intensities, polarizations, degrees of coherence, and/or angles of incidence, for example. Additionally, a perceived image may include data from a variety of types of sensors, radiation, and/or portions of the substrate or other substrates (e.g., an image of an average die). Further the data in a perceived image may be processed by, for example, applying various filtering, data fusion, and/or other image processing algorithms.

The term “candidate structure,” as used herein, refers to a model of a physical structure expected to appear in a perceived image, e.g., a finite element model of a particle or electronic device that might occur on a substrate. It should be noted that the term “candidate structure” is not limited to models that only encompass the geometry of a physical structure. A candidate structure may also model morphology, composition, crystallographic information, or other features of a physical structure that might appear on a substrate.

The term “simulated image,” as used herein, refers to an image that includes a simulated signature of a candidate structure, e.g., the result of a simulation that predicts the effect of a particle on ultraviolet light. In other words, a simulated image is produced by simulating the effect of a candidate structure on radiation of the sort used to generate the perceived image. That is, a simulated image predicts how a candidate structure would appear in a perceived image.

Finally, as used herein, the phrase “on a substrate” refers both to features in contact with the surface of a substrate and to features within a substrate, e.g., a scratch, crystal slip, or other defect buried under a film.

Returning to the classification method 10 illustrated by FIG. 1, receiving a perceived image of a substrate (depicted by block 12) may include receiving a perceived image generated by a RDA tool. For example, the perceived image may be received from a bright-field inspection tool, a dark field inspection tool, and/or an electron-beam inspection tool, or other system for imaging features on substrates in a manufacturing environment. To generate the perceived image, the RDA tool may direct radiation towards the surface of a substrate and detect the radiation returned from the substrate. The radiation may include electromagnetic radiation, an electron-beam, and/or an ion beam, for example. A number of sensors in the RDA tool may detect spatial and/or temporal variations in the radiation returned from the substrate over some area.

In one embodiment, a RDA tool illuminates the substrate with a beam of substantially monochromatic light and senses the light returned from the substrate. The perceived image in this embodiment may depict variations in the intensity of light returned from the substrate over some area, such as the area of an electronic imaging device. The bulk of the light illuminating the substrate may have a wavelength less than 266 nanometers, 248 nanometers, 193 nanometers, et cetera.

The perceived image may include a signature from a near-sub-wavelength physical structure, i.e., a physical structure with a critical dimension that is similar to, or smaller than, the wavelength of radiation illuminating the substrate. As used herein, a “critical dimension” refers to a dimension that has been identified as critical to the proper operation of the electronic device being fabricated, e.g., certain line widths, gate lengths, contact diameters, sidewall taper angles, particle diameters, scratch lengths, etc. In some embodiments, the perceived image includes a signature from a near-sub-wavelength physical structure to be classified with a critical dimension that is smaller than 0.05, 0.20, 0.40, 0.60, 0.80, 1.00, 1.50, 2.00, or 4.00 times the wavelength of the illuminating radiation. Similarly, certain exemplary embodiments employ a 266 nanometer laser to form a perceived image and classify a physical structures appearing in the perceived image with a critical dimension that is smaller than 72 nanometers, 55 nanometers, 45 nanometers, 35 nanometers, or 25 nanometers, for instance. As discussed above, the signature of a near-sub-wavelength physical structure may include distortions that make it difficult to accurately classify the near-sub-wavelength physical structure.

After a perceived image is received, a physical structure on the substrate is classified by comparing the perceived image to a simulated image, as indicated by block 14. As discussed in the following exemplary embodiments of this step, classifying a physical structure on the substrate may include classifying the physical structure as falling within some category of defect, measuring a dimension of the physical structure, and/or classifying the physical structure as a negligible physical structure that contributes noise to the perceived image. Additionally, other types of classification are also within the scope of the present technique, such as classifying the physical structure as having a particular morphology, composition, crystallographic feature, stress, orientation, and/or other feature.

In the present embodiment, to expedite classification, the simulated image to which the perceived image is compared is generated before receiving the perceived image. That is, the simulations are performed in advance of receiving the perceived image. Advantageously, generating the simulated images in advance may facilitate manufacturing process control. The simulations, details of which are explained below, may include time-consuming computations. By performing the simulations in advance, the output of the simulations, the simulated images, are prepared for quick retrieval when comparing them to a perceived image. As a result, the pre-generated simulations may be quickly compared to the perceived image, without waiting for the time-consuming generation of each simulated image, thereby facilitating rapid identification of processes that are damaging substrates. However, it should be noted that the present technique also encompasses simulating images after the perceived image is received and performing a portion of the simulation after the perceived image is received, e.g., completing the simulation after the perceived image as received.

In the present embodiment, the simulated image depicts the predicted interaction of a candidate structure and radiation of the type used to generate the perceived image. That is, the simulated image depicts the signature of the candidate structure. The simulation may take as inputs both parameters that describe the radiation directed at the substrate and parameters that characterize the candidate structure. The parameters that describe the radiation may include wavelength, angle of incidence, type, polarization, coherence, intensity, duration of sampling, and other features. The parameters that describe the candidate structure may include a finite element model, a wire-frame model, a cross-sectional model, or other model of the candidate structure. The simulation outputs the signature of the candidate structure in a simulated image. For example, the simulation may predict that an array of lines on the substrate will appear as light bands with a particular width and intensity. A variety of commercially available software packages may generate the simulated images such as EMFLEX or a combination of DIFFRACT and SIM3D_MAX, for example.

To classify a physical structure, a plurality of simulated images, each depicting a different candidate structure, may be prepared. As explained below in reference to FIG. 3, a variety of candidate structures may be input into the simulation software to generate a library of simulated images. Each candidate structure corresponds to a simulated image that depicts its signature. The candidate structures may vary in a systematic way between the simulated images, e.g., a scratch of increasing depth and/or length. A library of simulated images may be prepared to depict the appearance of a large number of candidate structures. To facilitate rapid classification, a pre-prepared library of simulated images may supply the simulated images to which the perceived image is compared.

In an exemplary embodiment of the classification method 10, a physical structure is classified by identifying a simulated image that matches the perceived image. Matching the images may include quantifying differences between the perceived image and the simulated image or other well known image processing techniques. Advantageously, once a match is identified, the inputs to the matching simulated image may facilitate classifying the physical structure that appears in the perceived image. Specifically, the physical structure may be classified as similar to the candidate structure appearing in the simulated image. In other words, by matching a simulated image to a perceived image, an unknown physical structure is correlated with a known candidate structure.

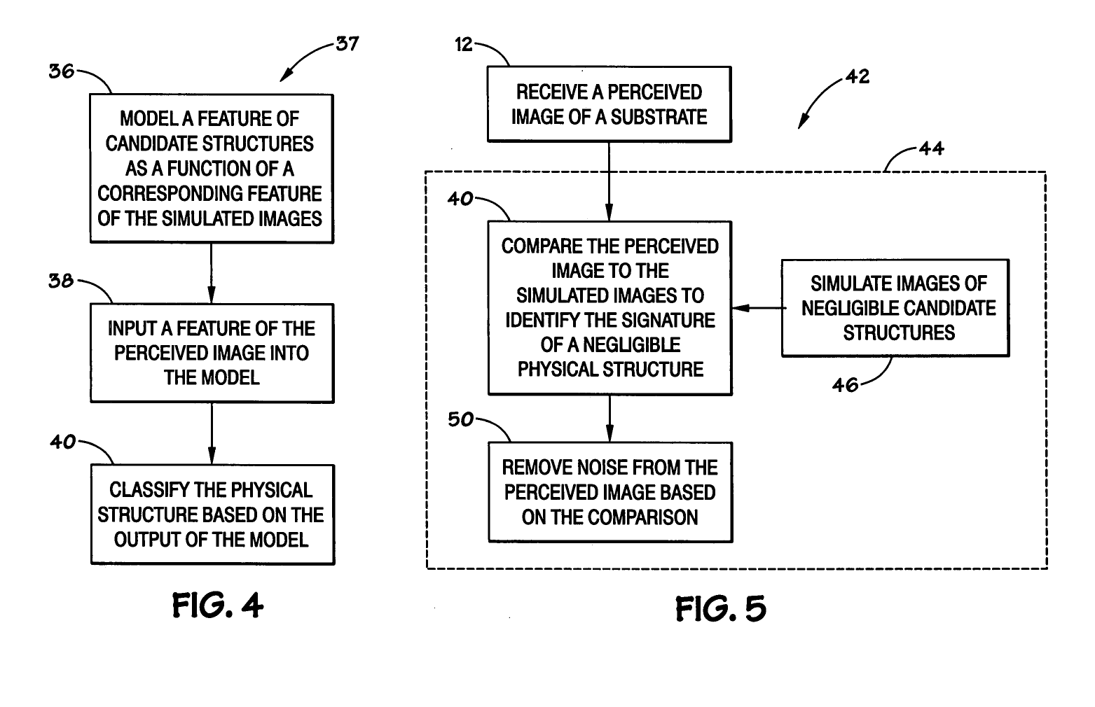

Alternatively, a simplified model may facilitate rapid classification of a physical structure. As is explained below in reference to FIG. 4, a feature of candidate structures may be correlated with a feature of their signatures in simulated images to form a simplified model. For example, a simplified model may correlate the width of a line in a candidate structure with the width of a dark band in simulated images. Once the relationship between the candidate structures and the simulated images is modeled in a simplified model, the resulting simplified model may classify a physical structure that produces a signature in a perceived image. To this end, upon inputting a feature of a signature in a perceived image, the simplified model may output an estimated feature of the physical structure that produced the signature. For instance, the simplified model may output an estimated width of a line on the substrate in response to inputting the width of a dark band in a perceived image. Moreover, the simplified model may avoid many of the time consuming computations associated with full simulations. As a result, the simplified model may rapidly classify a physical structure, thereby facilitating process control.

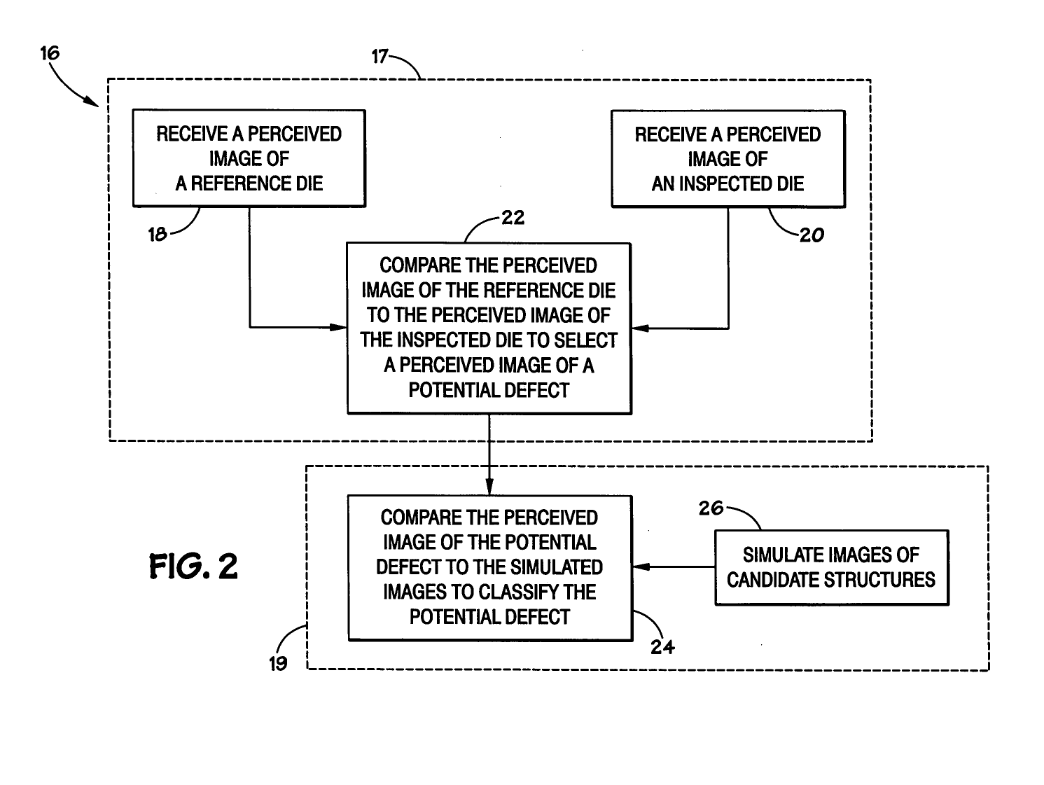

FIG. 2 depicts a method for classifying a potential defect, generally designated by the reference numeral 16, which is an exemplary embodiment of the classification method 10 illustrated by FIG. 1. The classification method 16 includes receiving an image of a substrate, as depicted by block 17 (which corresponds to the step depicted by block 12 of FIG. 1), and a physical structure on the substrate by comparing the perceived image to a simulated image, as illustrated by block 19 (which corresponds to the step depicted by block 14 of FIG. 1).

In the present embodiment, receiving a perceived image of a substrate, as depicted by block 17, includes receiving a perceived image of a referenced die, as depicted by block 18, receiving a perceived image of an inspected die, as depicted by block 20, and comparing the perceived images of the referenced die and the inspected die select a perceived image of a potential defect, as depicted by block 22. The substrate may include an array of die that, under ideal conditions, are substantially identical. A defect within an inspected die may be detected by comparing a perceived image of the inspected die to a perceived image of a reference die. Differences between the two perceived images may indicate the location of a potential defect on the inspected die. It is important to note that the present technique is not limited to die-to-die comparison of perceived images. Other embodiments may use different areas for comparison, for example, photo shot-to-photo shot comparison, block-to-block comparison, or other units of generally similar features on a substrate. As will be appreciated by those of skill in the art, receiving a perceived image of a referenced die, as depicted by block 18, may include averaging perceived images of several referenced die to limit the effect of an anomalous die on the comparison with an inspected die.

In the present exemplary embodiment, the image comparison depicted by block 22 selects a perceived image of a potential defect. The perceived image of a potential defect may be selected by identifying a perceived image of an inspected die that differs from the perceived image of the reference die. Alternatively, the perceived image of the inspected die and the perceived image of the reference die may be subtracted or otherwise combined to select a perceived image of a potential defect. In this embodiment, the potential defect is the physical structure that accounts for the difference between the perceived image of the reference die and the perceived image of the inspected die. That is, the difference between the two images is the signature of the potential defect.

Next, a physical structure, i.e. the potential defect in the present embodiment, is classified by comparing the perceived image to a simulated image, as indicated by block 19. In the present embodiment, classifying the physical structure includes simulating images of candidate structures, as depicted by block 26, and comparing the perceived image to the simulated images to classify the potential defect, as depicted by block 24. Simulating images of a candidate structures may include simulating images of defects that are likely to occur on a substrate, e.g., particles, stringers, delaminations, and scratches of various sizes. As discussed above, the simulations may run prior to receiving a perceived image of a defect to facilitate rapid classification, and a plurality of simulated images may each depict one of a variety of candidate structures to facilitate precise classification.

As discussed above, more than one method may perform the comparison depicted by block 24. For example, FIG. 3 depicts one embodiment of a library-based comparison method 27 for comparing the perceived image the simulated images. In the present embodiment, the library-based comparison method 27 includes generating a library of simulated images, as depicted by block 28, matching the perceived image of the potential defect to a similar simulated image, as depicted by block 30, and classifying the potential defect based on the candidate structure appearing in the similar simulated image, as depicted by block 32. Classifying the potential defect may include identifying the potential defect as being of the same or similar type, size, material, depth, or length of the candidate structure appearing in the closest simulated image.

As an alternative to the library-based comparison 27, FIG. 4 depicts a simplified model-based comparison method 37 for performing the comparison depicted by block 24. In the present embodiment, the simplified model-based comparison method 37 includes modeling a feature of candidate structures as a function of a corresponding feature in simulated images to create a simplified model, as depicted by block 36, inputting a feature of the perceived image into the simplified model, as depicted by block 38, and classifying the physical structure based on the output of the simplified model, as depicted by block 40.

FIG. 5 is a flowchart depicting an exemplary noise-filtering method 42 for filtering noise from a perceived image, which is another embodiment of the classification method 10 in FIG. 1. The noise-filtering method 42 may include receiving a perceived image of a substrate, as illustrated by block 12, and classifying a physical structure by comparing the perceived image to simulated images, as depicted by block 44, which is another embodiment of the step depicted by block 14. Receiving a perceived image of a substrate includes, in certain embodiments, the steps discussed in reference block 17 of FIG. 2. Alternatively, or additionally, receiving a perceived image may include selecting a portion of a perceived image that includes a certain physical structure with, for example, an image recognition algorithm.

In the present embodiment, classifying a physical structure by comparing the perceived image to a simulated image includes simulating images of a negligible candidate structures, as depicted by block 46, comparing the perceived image to the simulated images to identify the signature of a negligible physical structure, as depicted by block 40, and removing noise from the perceived image based on the comparison, as depicted by block 50. The comparison depicted by block 40 may include the library-based comparison method 27 of FIG. 3 or the simplified model-based comparison method 37 of FIG. 4.

As used herein, a “negligible physical structure” refers to a physical structure that produces a signature in the perceived image but is not relevant to interpreting the perceived image. That is, a “negligible physical structure” is a physical structure that adds noise to the perceived image. For example, negligible physical structures may include physical structures that do not significantly affect device performance. Similarly, as used herein, a “negligible candidate structure” is a candidate structure that would be a negligible physical structure were it to exist on a substrate.

Once a physical structure appearing in a perceived image is identified as negligible, noise in the perceived image from the negligible physical structure is removed, as depicted by block 50. In one embodiment, the signature of a negligible candidate structure that is identified as similar to the negligible physical structure in the comparison of block 40 is subtracted from the perceived image. Advantageously, by removing the signatures of negligible physical structures, the signatures of non-negligible physical structures may appear more clearly in the perceived image, thereby facilitating rapid classification of the non-negligible physical structures.

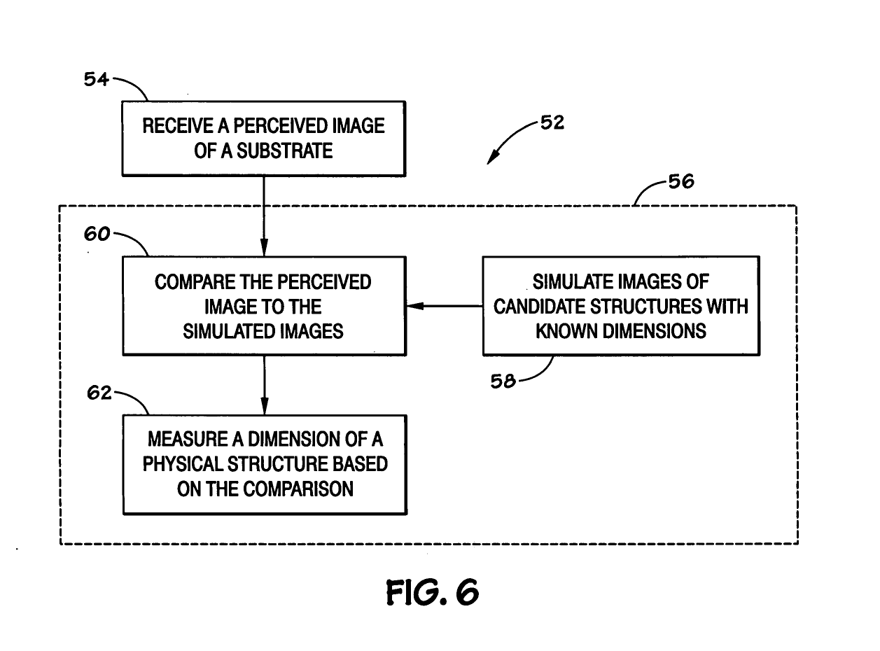

FIG. 6 is a flowchart depicting an exemplary measurement method 57 for measuring a physical structure, which is another embodiment of the classification method 10 in FIG. 1. The measurement method 52 may include receiving a perceived image of a substrate, as depicted by block 54, which is another embodiment of the step depicted by block 12, and classifying a physical structure by comparing the perceived image to simulated images, as depicted by block 56, which is another embodiment of the step depicted by block 14. In the present embodiment, classifying a physical structure includes measuring a physical structure by simulating images of candidate structures with a known dimension, as depicted by block 58, comparing the perceived image to the simulated images, as depicted by block 60, and estimating a dimension of the physical structure based on the comparison, as depicted by block 62.

The comparison depicted by block 60 may include the library-based comparison method 27 of FIG. 3 or the simplified model-based comparison method 37 of FIG. 4. For example, the perceived image may be compared to a library of simulated images depicting candidate structures with a dimension that varies between the simulated images. The perceived image may be matched to the most similar simulated image in the library, and the physical structure may be determined to have dimensions similar to the candidate structure appearing in the matching simulated image. Similarly, the perceived image may be compared to simulated images with a simplified model, such as one that correlates the width of the signature of a line with the width of the line.

Finally, a dimension of the physical structure may be measured based on the comparison of the perceived image to the simulated image. Measuring a dimension includes estimating that a dimension is within some range. The measured dimension may be a dimension of any physical structure on the substrate, such as a defect size or dimension of an electronic device manufactured on the substrate. Advantageously, the present technique may facilitate process control by rapidly measuring dimensions of physical structures on the surface of a substrate.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of classification, comprising:
receiving a perceived image of a substrate; and
classifying a physical structure on the substrate by comparing the perceived image to a simulated image.

2. The method of claim 1, wherein receiving a perceived image comprises:
receiving a perceived image of a reference area of a substrate;
receiving a perceived image of an inspected area of a substrate; and
comparing the perceived image of the reference area to the perceived image of the inspected area.

3. The method of claim 2, wherein the reference area is a die, and wherein the inspected area is a die.

4. The method of claim 1, wherein receiving a perceived image of a substrate comprises:
directing electromagnetic radiation at the substrate; and
sensing electromagnetic radiation returned from the substrate over an area to form an image.

5. The method of claim 4, wherein classifying a physical structure on the substrate comprises classifying a physical structure with a critical dimension that is smaller that the wavelength of the electromagnetic radiation directed at the substrate.

6. The method of claim 1, wherein classifying a physical structure on the substrate comprises:
simulating images of candidate structures before the perceived image is received;
comparing the perceived image to the simulated images; and
classifying a potential defect appearing in the perceived image based on the comparison.

7. The method of claim 6, wherein comparing the perceived image to the simulated image comprises:
generating a library of simulated images; and
matching the perceived image to a similar simulated image in the library.

8. The method of claim 6, wherein comparing the perceived image to the simulated image comprises:
generating a simplified model of a feature of the candidate structures as a function of a corresponding feature of the simulated images;
inputting a feature of the perceived image into the simplified model; and
outputting a feature of the potential defect.

9. The method of claim 1, wherein classifying a physical structure on the substrate comprises:
simulating images of negligible candidate structures before the perceived image is received; and
comparing the perceived image to the simulated images; and
filtering noise from the perceived image based on the comparison.

10. The method of claim 9, wherein comparing the perceived image to the simulated image comprises:
generating a library of simulated images;
matching the perceived image to a similar simulated image in the library; and
classifying the physical structure as a negligible physical structure based on the similar simulated image.

11. The method of claim 9, wherein comparing the perceived image to the simulated image comprises:
generating a simplified model of a feature of the negligible candidate structures as a function of a corresponding feature of the simulated images;
inputting a feature of the perceived image into the simplified model; and
classifying the physical structure as a negligible physical structure based on the output of the simplified model.

12. The method of claim 1, wherein classifying a physical structure on the substrate comprises:
simulating images of candidate structures before the perceived image is received;
comparing the perceived image to the simulated images; and
measuring a dimension of the physical structure based on the comparison.

13. The method of claim 12, wherein comparing the perceived image to the simulated image comprises:
generating a library of simulated images; and
matching the perceived image to a similar simulated image in the library.

14. The method of claim 12, wherein comparing the perceived image to the simulated image comprises:
generating a simplified model of a feature of the candidate structures as a function of a corresponding feature of the simulated images; and
inputting a feature of the perceived image into the simplified model.

15. A classification tool, comprising:
a real-time defect analysis tool; and
a tangible machine readable medium having instructions for:
receiving a perceived image of a substrate; and
classifying a physical structure on the substrate by comparing the perceived image to a simulated image.

16. The classification tool of claim 15, wherein the real-time defect analysis tool is at least one of a bright-field inspection tools or a dark field inspection tool or a combination of a bright-field inspection tool and a dark field inspection tool.

17. The classification tool of claim 15, wherein the real-time defect analysis tool comprises an electron-beam inspection tool.

18. The method of claim 15, wherein classifying a physical structure on the substrate comprises:
simulating images of candidate structures before the perceived image is received;
comparing the perceived image to the simulated images; and
classifying a potential defect appearing in the perceived image based on the comparison.

19. The method of claim 18, wherein comparing the perceived image to the simulated image comprises:
generating a library of simulated images; and
matching the perceived image to a similar simulated image in the library.

20. The method of claim 18, wherein comparing the perceived image to the simulated image comprises:
generating a simplified model of a feature of the candidate structures as a function of a corresponding feature of the simulated images;
inputting a feature of the perceived image into the simplified model; and
outputting a feature of the potential defect.

21. The method of claim 15, wherein classifying a physical structure on the substrate comprises:
simulating images of negligible candidate structures before the perceived image is received;
comparing the perceived image to the simulated images; and
filtering noise from the perceived image based on the comparison.

22. The method of claim 21, wherein comparing the perceived image to the simulated image comprises:
generating a library of simulated images;
matching the perceived image to a similar simulated image in the library; and
classifying the physical structure as a negligible physical structure based on the similar simulated image.

23. The method of claim 21, wherein comparing the perceived image to the simulated image comprises:
generating a simplified model of a feature of the negligible candidate structures as a function of a corresponding feature of the simulated images;
inputting a feature of the perceived image into the simplified model; and
classifying the physical structure as a negligible physical structure based on the output of the simplified model.

24. The method of claim 15, wherein classifying a physical structure on the substrate comprises:
simulating images of candidate structures before the perceived image is received;
comparing the perceived image to the simulated images; and
measuring a dimension of the physical structure based on the comparison.

25. The method of claim 24, wherein comparing the perceived image to the simulated image comprises:
generating a library of simulated images; and
matching the perceived image to a similar simulated image in the library.

26. The method of claim 24, wherein comparing the perceived image to the simulated image comprises:
generating a simplified model of a feature of the candidate structures as a function of a corresponding feature of the simulated images; and
inputting a feature of the perceived image into the simplified model.

27. A method of manufacturing a classification tool, comprising:
providing a tangible machine readable medium having instructions for receiving a perceived image of a substrate and
classifying a physical structure on the substrate by comparing the perceived image to a simulated image.
